(19) United States
(12) Patent Application Publication
(10) Pub. No.: US 2012/0013578 A1
(43) Pub. Date: Jan. 19, 2012

(54) PEN-SHAPED POINTING DEVICE AND SHIFT CONTROL METHOD THEREOF

(75) Inventors: Yu-Wen Huang, New Taipei City (TW); Ching-Chao Tsai, New Taipei City (TW); Hsu-Chih Chen, New Taipei City (TW); Yih-Sheng Chao, New Taipei City (TW)

(73) Assignee: AVERMEDIA INFORMATION, INC., New Taipei City (TW)

(21) Appl. No.: 13/032,278

(22) Filed: Feb. 22, 2011

(30) Foreign Application Priority Data
Jul. 15, 2010 (TW) 099123303

(51) Int. Cl. G06F 3/033

(52) U.S. Cl. 345/179

(57) ABSTRACT

A shift control method is used with a pen-shaped pointing device and a controlled device. Firstly, shift information, tilt angle information and rotating angle information in response to a configuration change of the pointing device relative to a supporting plane are sensed. Then, a shift estimation operation is performed by the controlled device according to the shift information, the tilt angle information and the rotating angle information, thereby acquiring a position-compensating data. If the pointing device is in contact with the supporting plane, a moving trajectory of the pointing device displayed by the controlled device is adjusted according to the position-compensating data.

### FIELD OF THE INVENTION

The present invention relates to a shift control method, and more particularly to a shift control method for use with a pen-shaped pointing device and a controlled device.

### BACKGROUND OF THE INVENTION

A variety of input devices are commonly used with a computer system, for example a keyboard, a mouse, an optical pen mouse, etc. With the input device, the user may input information or give an instruction for controlling operations of the computer system. Generally, an optical pen mouse is a pen-shaped pointing device. The operating principle of an optical pen mouse is similar to a common optical mouse. An optical shift sensor is commonly used in an optical pen mouse to determine the motion of the optical pen mouse relative to its supporting plane by detecting the change in grain pattern of the supporting surface. Based on the detected change, the shift information of the optical pen mouse, including changes in direction and distance, can be realized. According to the shift information of the optical pen mouse, the cursor shown on a display of the computer system can be controlled.

Conventionally, the way of sensing the shift of an optical pen mouse is similar to that used for sensing an optical mouse. Since the way of sensing the shift of an optical pen mouse is not directly perceived, the shift trajectory detected by the optical shift sensor of the conventional optical pen mouse is hard to reflect the movement of the optical pen mouse in the supporting plane by way of an absolute coordinate system, so the detecting performance would be unsatisfactory. Under this circumstance, when using the optical pen mouse, the user needs to observe the cursor trajectory shown on the display device to correlate the cursor trajectory to the movement of the optical pen mouse in the supporting plane. Otherwise, the cursor trajectory might be inconsistent with the movement of the optical pen mouse in the supporting plane.

FIG. 1A schematically shows an ideal correlation of movement of a conventional optical pen mouse on a supporting plane to cursor shift on a display with the optical pen mouse schematically illustrated in a top view. As shown in FIG. 1A, when the orientation of the pen-shaped body of the optical pen mouse 10 is consistent with the reference basis (i.e. a x-y coordinate system), the moving trajectory of the optical pen mouse 10 on the supporting plane will be well corresponding to the cursor shift on the display device. For different users or in different situation, however, the way of holding the optical pen mouse 10 may be changed. For example, when the optical pen mouse 10 is used for writing, the pen-shaped body of the optical pen mouse 10 might not be always oriented in the same way. During operation of the optical pen mouse 10, if the pen-shaped body of the optical pen mouse 10 is rotated an angle so as to deviate from the perfect orientation as shown in FIG. 1A, the cursor trajectory shown on the display device would not follow the moving trajectory of the optical pen mouse 10 on the supporting plane. FIG. 1B is one of the examples.

FIG. 1B shows an exemplary correlation of movement of a conventional optical pen mouse on a supporting plane to cursor shift on a display with the optical pen mouse schematically illustrated in a top view. Since the optical pen mouse 10 as shown is deviated from the perfect orientation as shown in FIG. 1A at an angle, the moving trajectory of the optical pen mouse 10 on the supporting plane becomes inconsistent with the cursor shift on the display. For example, while the optical pen mouse 10 is moved in the leftward direction, the cursor shift on the display is moved in the right-and-downward direction.

For solving this problem, the optical pen mouse 10 is generally provided with an aligning mark (not shown) to assure of orientation consistency with the reference basis. Whenever the optical pen mouse 10 is placed down and picked up to write again, the user needs to repeatedly confirm the orientation of the pen-shaped body through the aligning mark. The way of operating the optical pen mouse 10 as such is not user-friendly. Furthermore, due to the dynamically operated feature of the optical pen mouse 10, deviation of the aligning mark from the reference basis of the display device occurs frequently. Then, the orientation of the pen-shaped body of the optical pen mouse 10 need be adjusted at times during the operation of the optical pen mouse 10. It would bother the user and make the user unwilling to use the device. The problem becomes more serious if two or more users take turns to use the optical pen mouse 10, for example in a meeting.

### SUMMARY OF THE INVENTION

The present invention provides shift control method for use with a pen-shaped pointing device and a controlled device. Firstly, shift information, tilt angle information and rotating angle information in response to a configuration change of the pointing device relative to a supporting plane are sensed. Then, a shift estimation operation is performed by the controlled device according to the shift information, the tilt angle information and the rotating angle information, thereby acquiring a position-compensating data. If the pointing device is in contact with the supporting plane, a moving trajectory of the pointing device displayed by the controlled device is adjusted according to the position-compensating data.

The present invention also provides a pen-shaped pointing device in communication with a controlled device. The pen-shaped pointing device includes a pen-shaped body and a sensing unit. The sensing unit is disposed in the pen-shaped body for detecting shift information, tilt angle information and rotating angle information in response to a configuration change of the pointing device relative to a supporting plane. The controlled device performs a shift estimation operation according to the shift information, the tilt angle information and the rotating angle information to acquire a position-compensating data. If the pointing device is in contact with the supporting plane, the controlled device adjusts a moving trajectory of the pointing device displayed by a controlled device according to the position-compensating data.

The present invention provides a shift control system. The shift control system includes at least one pointing device and a controlled device. The pointing device includes a casing and a sensing unit. The sensing unit is disposed inside the casing for detecting shift information, tilt angle information and rotating angle information in response to a configuration change of the pointing device relative to a supporting plane. The controlled device is in communication with the at least one pointing device for performing a shift estimation operation according to the shift information, the tilt angle information and the rotating angle information to acquire a position-compensating data. If the pointing device is in contact with the supporting plane, the controlled device adjusts a moving trajectory of the pointing device displayed by a controlled device according to the position-compensating data.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1A schematically shows an ideal correlation of movement of a conventional optical pen mouse on a supporting plane to cursor shift on a display with the optical pen mouse schematically illustrated in a top view;

FIG. 1B schematically shows a real correlation of movement of a conventional optical pen mouse on a supporting plane to cursor shift on a display with the optical pen mouse schematically illustrated in a top view;

FIG. 2 is a flowchart illustrating a shift control method for use in a shift control system according to the present invention;

FIG. 3A schematically illustrates a reference basis dynamically changeable so as to comply with orientation of a pen-shaped pointing device according to an embodiment of the present invention;

FIG. 3B schematically shows a correlation of the change of reference basis to the movement of the optical pen mouse on a supporting plane according to an embodiment of the present invention;

FIG. 4A schematically illustrates a shift control system using a single pointing device for input according to an embodiment of the present invention;

FIG. 4B schematically illustrates a shift control system using a plurality of pointing devices for input according to an embodiment of the present invention;

FIG. 4C schematically illustrates a pointing device having a position-compensating function according to an embodiment of the present invention;

FIG. 5 is a flowchart illustrating an embodiment of the shift control method of FIG. 2;

FIG. 6 is a flowchart illustrating a shift estimation operation performed by an optical pen mouse according to a first embodiment of the present invention;

FIG. 7 is a flowchart illustrating a shift estimation operation performed by an optical pen mouse according to a second embodiment of the present invention;

FIG. 8A schematically illustrates the relationship between the body coordinate system (dynamic operating basis) and the navigation coordinate system (reference basis) according to the present invention; and

FIG. 8B schematically illustrates detected information acquired by a sensing unit of a pen-shaped pointing device based on the reference basis and the operating basis.

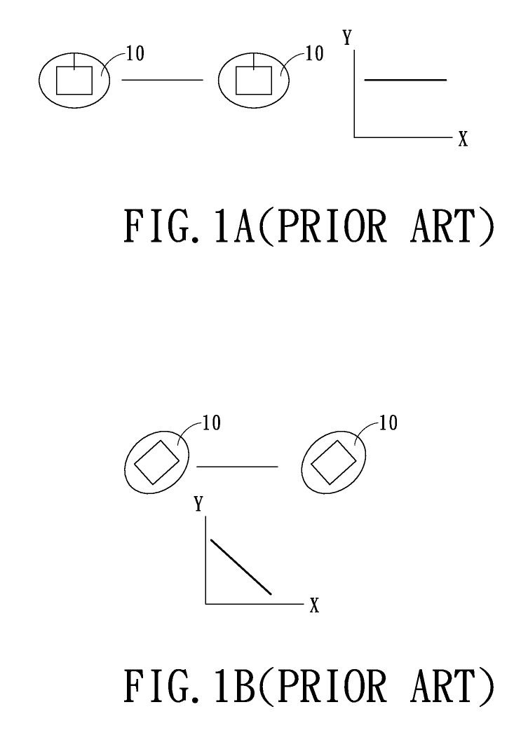

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

For solving the drawbacks encountered from the prior art, the present invention provides a shift control method. Firstly, a sensing unit within the optical pen mouse is used to acquire a position-compensating data for correcting the rotating angle. According to the position-compensating data, the deviation between the dynamic operating basis of the pointing device and the reference basis is compensated. As a consequence, the moving trajectory shown on the display device is more consistent with the movement of the actual movement of the pointing device.

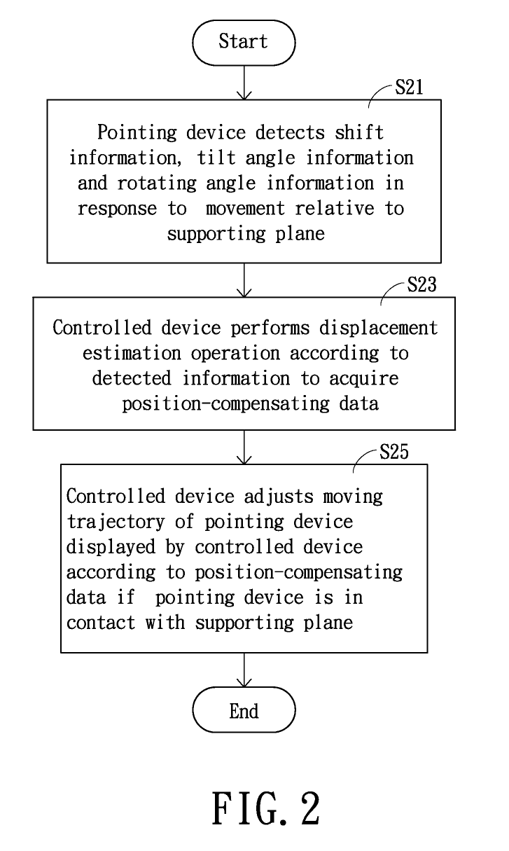

FIG. 2 is a flowchart illustrating a shift control method for use in a shift control system according to an embodiment of the present invention. The shift control system comprises at least one pen-shaped pointing device (e.g. an optical pen mouse) and a controlled device (e.g. a personal computer). The shift control method will be illustrated as follows.

In response to a user's operating behavior (e.g. movement, rotation or a rolling action) on the pointing device, the configuration of the pointing device relative to the supporting plane is changed. By using a sensing unit to detect the configuration change amount, associated detected information (e.g. shift information, tilt angle information and rotating angle information) will be acquired (Step S21). After the detected information is acquired, the controlled device performs a shift estimation operation according to the detected information, and acquires a position-compensating data by the shift estimation operation (Step S23). After the position-compensating data is acquired, if the pointing device is contacted with the supporting plane, the moving trajectory of the pointing device displayed by the controlled device is adjusted according to position-compensating data (Step S25).

On the other hand, in a case that the pointing device is not contacted with the supporting plane, it means that the pointing device is only held by the user's hand. Although the configuration change of the pointing device relative to the supporting plane may be detected by the sensing unit at this moment, it is not necessary to correlate the configuration change to the moving trajectory of the pointing device displayed by the controlled device. Meanwhile, the position-compensating data is stored to be used in the next position-compensation. Whereas, in a case that the pointing device is contacted with the supporting plane, it means that the pointing device is used to write. Meanwhile, the shift control system not only stores the position-compensating data to be used in the next shift estimation operation, but also changes the moving trajectory of the pointing device displayed by the controlled device according to position-compensating data.

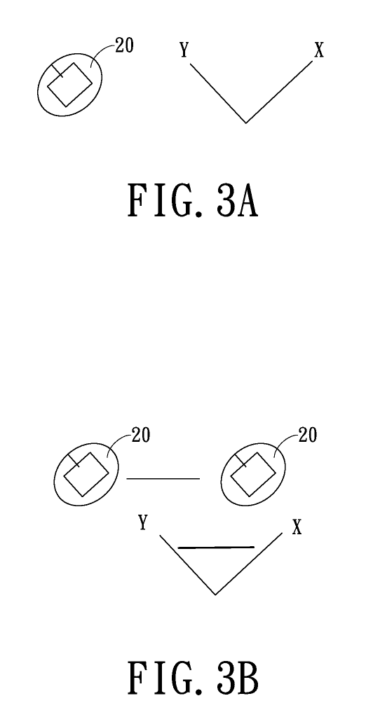

FIG. 3A schematically illustrates a reference basis dynamically changeable so as to comply with orientation of a pen-shaped pointing device according to an embodiment of the present invention. As shown in FIG. 3A, if the pen-shaped body of the positioning device 20 is rotated by an angle, the reference basis (i.e. a x-y coordinate system) of the display device is correspondingly rotated by the same angle. In other words, according to the orientation of the positioning device 20, the reference basis (i.e. the x-y coordinate system) of the display device is adjusted. Consequently, the adjusted reference basis is parallel with the dynamic operating basis of moving the positioning device 20. It is noted that the reference basis is a basis for estimating the position-compensating data but the x-y coordinate system displayed by the display device is not correspondingly rotated.

FIG. 3B schematically illustrates shows a correlation of the change of reference basis to the movement of the optical pen mouse on a supporting plane according to an embodiment of the present invention. As shown in FIG. 3B, after the position-compensating data is acquired and the position-compensation is done, since the reference basis and the dynamic operating basis are consistent with each other, the movement of the pointing device 20 and the moving trajectory relative to the reference basis will be consistent with each other. In other words, the moving trajectory of the pointing device 20 shown on the display device is not deviated.

For clarification and brevity, the real movement of the pointing device 20 and the moving trajectory of the moving trajectory shown on the display device are expressed by two-dimensional coordinate systems. It is noted that the configuration change of the pointing device relative to the supporting plane may be expressed by a three-dimensional system. That is, when the shift estimation operation is performed, the configuration changed relative to the direction perpendicular to the supporting plane should also be taken into consideration.

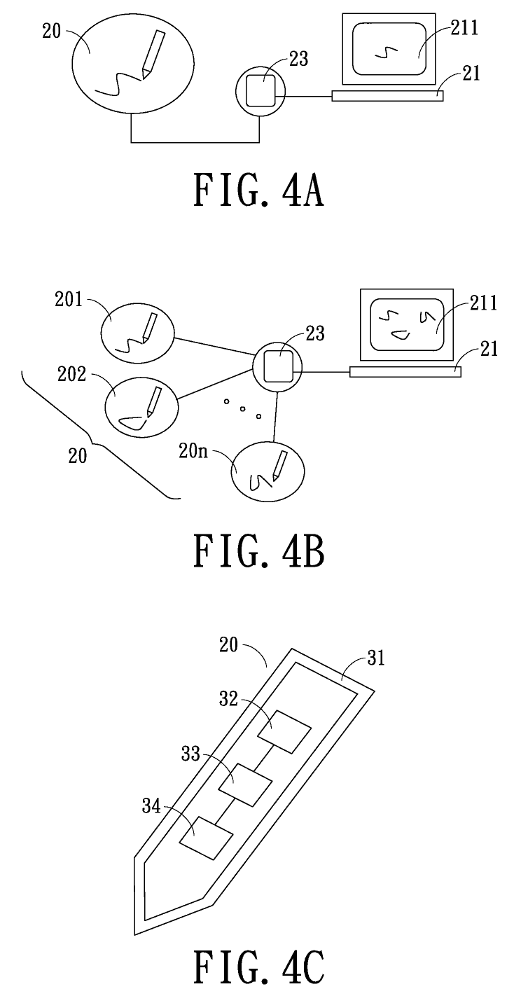

FIG. 4A schematically illustrates a shift control system using a single pointing device for input according to an embodiment of the present invention. As shown in FIG. 4A, the shift control system comprises a single pen-shaped pointing device 20 (e.g. an optical pen mouse or a digital pen mouse) and a controlled device 21 (e.g. a personal computer). The pointing device 20 is in communication with the controlled device 21 through a transceiver 23. That is, after the dynamic information from the pointing device 20 is received by the transceiver 23, the dynamic information is transmitted to the controlled device 21. After the dynamic information from the pointing device 20 is received by the controlled device 21, the further action is performed depending on whether the pointing device 20 is contacted with the supporting plane or not. If the pointing device 20 is not contacted with the supporting plane, the position-compensating data is stored or updated to be used in the next position-compensation. Whereas, if the pointing device 20 is contacted with the supporting plane, the moving trajectory of the pointing device 20 shown on the display device 211 is also adjusted according to position-compensating data.

FIG. 4B schematically illustrates a shift control system using a plurality of pointing devices for input according to an embodiment of the present invention. As shown in FIG. 4B, the shift control system comprises plural pen-shaped pointing devices 201˜20n and a controlled device 21. Firstly, the pointing devices 201˜20n are in communication with the transceiver 23 according to a wireless transmission technology to exchange data. Then, through the transceiver 23, the dynamic information from the pointing devices 201˜20n will be transmitted to the controlled device 21 that is connected with the transceiver 23.

In a case that the shift control system comprises plural pointing devices 20 as shown in FIG. 4B, identification codes are assigned to respective pointing devices 201˜20n. After the dynamic information is received by the controlled device 21, the dynamic information from respective pen-shaped pointing devices 201˜20n will be recognized according to the identification codes during the procedure of recognizing and processing the shift information.

One the other hand, when the dynamic information is transmitted from respective pen-shaped pointing devices 201˜20n to the controlled device 21 through the transmitting units 21 of the respective pen-shaped pointing devices 201˜20n in response to the user's operating behavior, the identification codes are simultaneously transmitted from respective pen-shaped pointing devices 201˜20n to the controlled device 21. Then, according to the identification codes and the position-compensating data of respective pen-shaped pointing devices 201˜20n, the moving trajectories of respective pen-shaped pointing devices 201˜20n shown on the display device 211 of the controlled device 21 are correspondingly adjusted.

In such way, the dynamic information from the plural pen-shaped pointing devices 201˜20n may be simultaneously received by the controlled device 21. According to the identification codes, the dynamic information from respective pen-shaped pointing devices 201˜20n will be realized. After the dynamic information from the respective pen-shaped pointing devices 201˜20n is received by the controlled device 21, the further action is performed depending on whether the respective pen-shaped pointing devices 201˜20n are contacted with the supporting plane or not. In addition, in a case that the pointing devices 201˜20n are contacted with the supporting plane, the moving trajectories of respective pointing devices 201˜20n shown on the display device 211 of the controlled device 21 or a display device (not shown) have specified features. For example, the moving trajectory of the first pointing device 201 is marked in a red color, and the moving trajectory of the second pointing device 202 is marked in a blue color. The different colors of moving trajectories of respective pointing devices 201˜20n are simultaneously shown on the display device 211.

Regardless of whether the shift control system comprises a single pointing device 20 (see FIG. 4A) or plural pointing devices 201˜20n (see FIG. 4B), the data transmission protocol of the transceiver 23 as a transmission medium between the controlled device 21 and the pointing device 20 or the plural pointing devices 201˜20n is not restricted. For example, the data transmission protocol may be in a wired, wireless, serial or parallel format. According to the wired, wireless, serial or parallel-format data transmission protocol, data exchange between the pointing devices 201˜20n, the transceiver 23 and the controlled device 21 will be rendered.

For example, the transceiver 23 may communicate with the controlled device 21 through a USB interface or any other data transmission interface. In addition, the transceiver 23 may communicate with the pointing device 20 (e.g. a digital pen mouse) according to a wireless transmission technology such as IEEE 802.15.4 (ZigBee), Bluetooth or IR wireless transmission technology. Of course, the process of processing the detected information is not restricted by the data transmission protocol.

FIG. 4C schematically illustrates a pointing device having a position-compensating function according to an embodiment of the present invention. The pointing device 20 may be used to control the controlled device 21 in the shift control system as shown in FIG. 4A or 4B. For complying with the habitual behaviors of most users, the pointing device 20 has a pen-shaped body. As shown in FIG. 4C, the pointing device 20 comprises a pen-shaped body 31 (or casing) and a sensing unit 32 within the pen-shaped body 31. The sensing unit 32 is used for detecting the configuration change of the pointing device relative to the supporting plane in response to the user's operating behavior on the pointing device 20, thereby acquiring associated detected information (e.g. shift information, tilt angle information and rotating angle information). After the detected information associated with the movement of the pointing device 20 is acquired by the sensing unit 32, the controlled device performs a shift estimation operation according to the detected information, and acquires a position-compensating data for calculating the moving trajectory of the pointing device 20 shown on the display device.

In some embodiments, the pointing device 20 further comprises a controlling unit 33 and a transmitting and receiving unit 34, which are electrically connected with the sensing unit 32. The detected information (e.g. shift information, tilt angle information and rotating angle information) sensed by the sensing unit 34 in response to the user's operating behavior on the pointing device may be transmitted from the controller 33 to the controlled device 21 through the transmitting and receiving unit 34 to exchange data. Of course, the shift estimation operation may be performed by the built-in controlling unit 33 of the pointing device 33. Alternatively, when the computing amount of the system is considered, the detected information may be directly transmitted to the controlled device 21, and thus the shift estimation operation is performed by the controlled device 21.

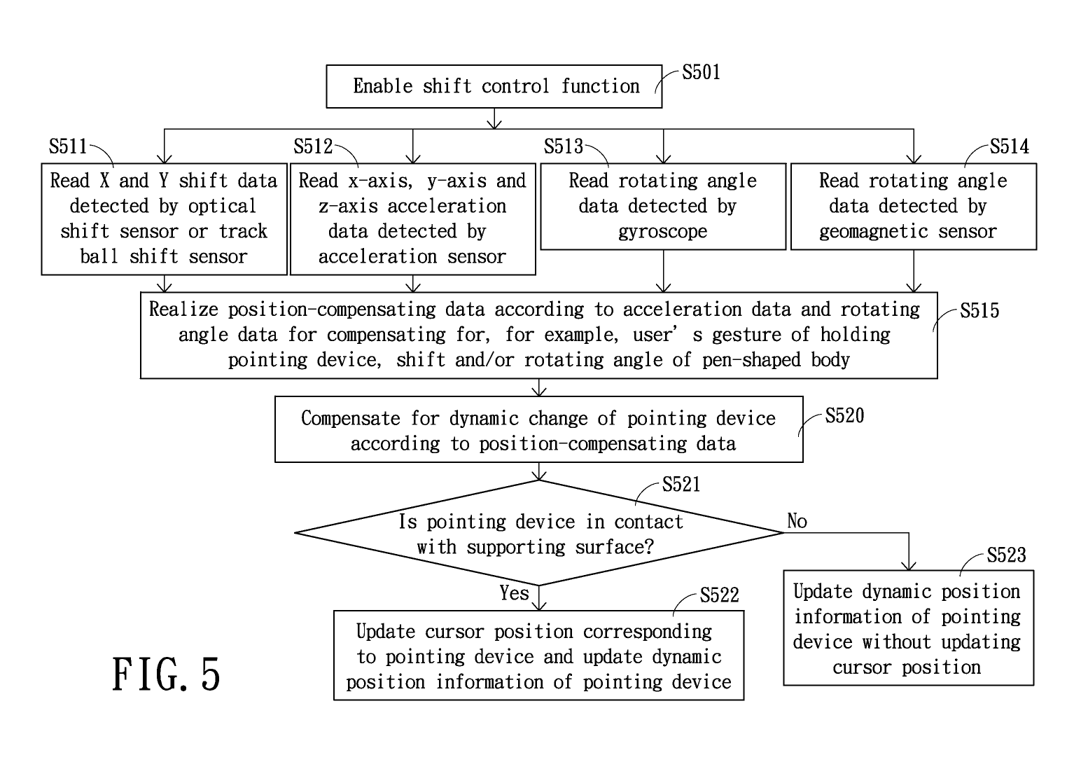

Hereinafter, a shift control method according to an embodiment of the present invention will be illustrated with reference to FIG. 5. Firstly, a shift information adjusting function of the pointing device is enabled (Step S501). Then, different types of sensing units within the pointing device are used to sense different types of dynamic detected data (Steps S511˜S514).

The ways of detecting different types of dynamic detected data will be illustrated as follows. In Step S511, an optical shift sensor or a track ball shift sensor is used to detect the movement of the pointing device with reference to the reference basis, thereby acquiring X and Y shift data. In Step S512, an acceleration sensor is used to read the acceleration of the pointing device relative to the x-axis, y-axis and z-axis. In Step S513, a gyroscope is used to detect the rotating angle of the pointing device. In Step S514, a geomagnetic sensor is used to detect the rotating angle of the pointing device.

After the shift data, the acceleration and the rotating angle are acquired, the shift estimation operation is performed on the pointing device to realize the position-compensating data (e.g. the user's gesture of holding the pointing device, the shift data and the rotating angle of the pen-shaped body) (Step S515). For example, the shift estimation operation is performed according to a fuzzy theory, a Kalman filter algorithm or other algorithm. Base on the previous status of the pointing device, the dynamic change of the pointing device is compensated according to the position-compensating data (Step S520).

By the way, the dynamic change of the pointing device relative to the supporting plane (e.g. the user's gesture of holding the pointing device, the shift data and the rotating angle of the pen-shaped body) may be calculated by using the sensing unit (e.g. the optical shift sensor, the track ball shift sensor, the acceleration sensor, the gyroscope or the geomagnetic sensor) to detect the dynamic detected data and performing the shift estimation operation.

Then, the step S521 is performed to judge whether the pointing device is contacted with the supporting plane. If the pointing device is contacted with the supporting plane, the cursor position corresponding to the pointing device and shown on the display device is updated by the position-compensating data and the dynamic position information of the pointing device is updated (Step S522). Whereas, if the pointing device is not contacted with the supporting plane, the dynamic position information of the pointing device is updated, but the cursor position corresponding to the pointing device and displayed by the controlled device is not updated (Step S523).

In a case that the shift control system comprises plural pointing devices, the above-mentioned data processing and controlling procedures are similar but the identification codes are previously assigned to respective pointing devices. During the process of transmitting the detected information of respective pointing devices, respective identification codes are also transmitted. When the controlled device is in communication with respective pointing devices, the recognition codes and the detected information from respective pointing devices are transmitted to the controlled device. According to the identification codes and the position-compensating data, the cursor positions corresponding to respective pointing devices and shown on the display device are adjusted.

The pen-shaped pointing device of the present invention is in communication with the controlled according to a wireless transmission technology such as IEEE 802.15.4 (ZigBee), Bluetooth or IR wireless transmission technology. The configuration change of the pointing device relative to the supporting plane in response to a user's operating behavior (e.g. movement, rotation or a rolling action) on the pointing device is sensed by the sensing unit (e.g. the optical shift sensor, the track ball shift sensor, the acceleration sensor, the gyroscope or the geomagnetic sensor) within the pointing device. After the detected information (e.g. shift information, tilt angle information and rotating angle information) is acquired, the shift estimation operation is performed according to a fuzzy theory, a Kalman filter algorithm or other algorithm. According to the position-estimating result, the the dynamic change of the pointing device is compensated.

Moreover, the pen-shaped pointing device may optionally provide a transmitting unit. The transmitting unit is electrically connected with the sensing unit. For performing the shift estimation operation, the detected information acquired by the sensing unit is transmitted to the controlled device through the communication between the pointing device and the controlled device.

The shift control method of the present invention will be illustrated in more details as follows.

Firstly, different types of sensing units within the pointing device are used to sense different types of dynamic detected data (Steps S511˜S514).

In Step S511, an optical shift sensor or a track ball shift sensor (see Taiwanese Patent No. 1254238) may be installed on the tip of the pen-shaped body of the pointing device to detect the moving trajectory of the pointing device with reference to the reference basis, thereby acquiring X and Y shift data. Alternatively, a high-hardness transparent pen head with an optical shift sensor is used to acquire X and Y shift data. Of course, different types of shift sensors may be used to acquire X and Y shift data.

In Step S512, an acceleration sensor is used to detect acceleration of the pointing device relative to the x-axis, y-axis and z-axis, thereby realizing the user's gesture of holding the pointing device and the shift data. In Step S513, a gyroscope is used to detect the rotating angle of the pointing device, thereby realizing the user's gesture of holding the pointing device. In Step S514, a geomagnetic sensor is used to detect the azimuth angle of the pointing device.

After different types of dynamic detected data are detected by different types of sensing units, the dynamic change of the pointing device is compensated according to the position-compensating data (Step S520). For example, the shift estimation operation is performed according to a Kalman filter algorithm. The Kalman filter algorithm is an optimal recursive data processing algorithm for processing recursive data.

The Kalman filter algorithm uses an analysis field and the detected data to obtain an optimal solution. If new detected data are generated during the shift estimation operation is performed, the optimal solution is analyzed according to a predictive value and the detected data, thereby acquiring another optimal solution to be used in a next shift estimation operation. After the Kalman filter algorithm is used for a time period, the predictive result will approach the observed result and the error is reduced to achieve a balance status. That is, the estimated position obtained by the Kalman filter algorithm is closer to the real position of the pointing device than the sensing amount sensed by the sensing unit because the detected data sensed by the sensing unit have inherent errors but the weighted average has a better predictive uncertainty.

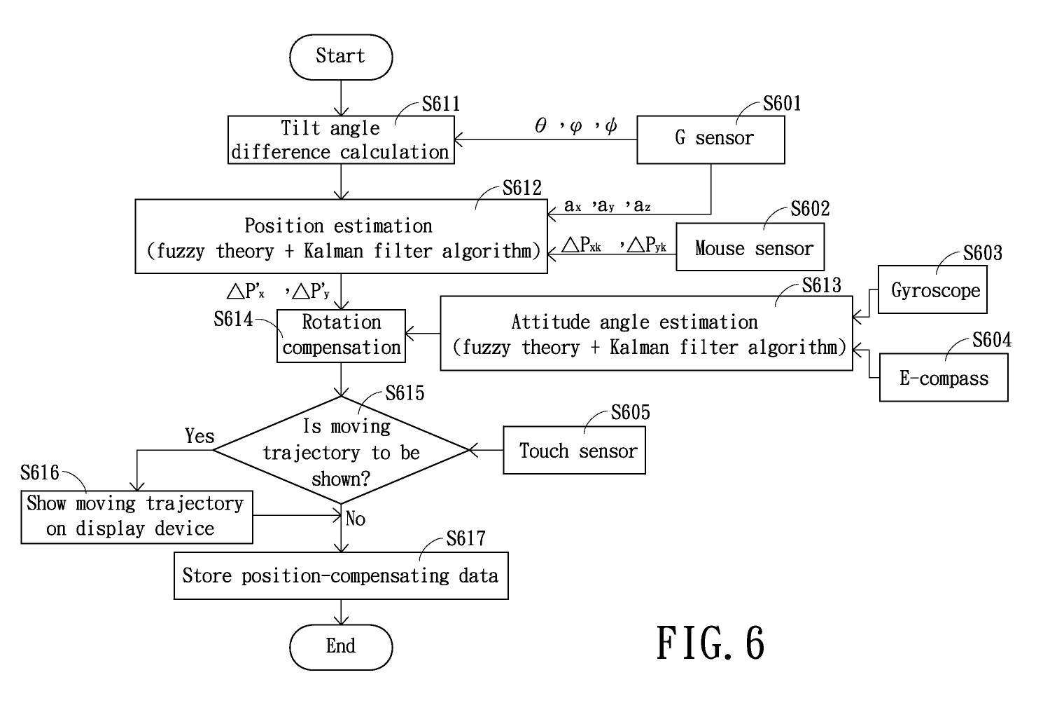

FIG. 6 is a flowchart illustrating a shift estimation operation performed by an optical pen mouse according to a first embodiment of the present invention. Firstly, a G sensor is used to detect the configuration change of the optical pen mouse relative to the supporting plane, thereby acquiring a rotating angle information (θ, _{ψ}, ψ) and an acceleration information (aₓ, a_{y}, a_{z}) (Step S601). By using a rotating angle look-up table, a tilt angle difference is calculated according to the rotating angle information (θ, _{ψ}, ψ) outputted from the G sensor (Step S611). Then, the acceleration sensed by the G sensor is integrated to acquire a first set of shift data. Moreover, a mouse sensor is used to sense a second set of shift data ΔPₓ, ΔP_{y} (Step S602). The first set of shift data and the second set of shift data are processed by the fuzzy theory and the Kalman filter algorithm, thereby acquiring optimal shift data ΔP′ₓ, ΔP′_{y} (Step S612). Then, an attitude angle is measured by a gyroscope (Step S603), and the attitude angle is measured by an e-compass (Step S604). The attitude angle measured by the gyroscope and the attitude angle measured by the e-compass are processed by the fuzzy theory and the Kalman filter algorithm, thereby acquiring an optimal attitude angle (Step S613). After the optimal shift data and the optimal attitude angle are acquired, the moving trajectory of the pointing device is calculated by a rotation compensation algorithm (Step S614). Then, a touch sensor is used to judge whether the pointing device is contacted with the supporting plane (Step S605) in order to further determine whether the compensated moving trajectory is shown on the display device (Step S615). If the compensated moving trajectory needs to be shown on the display device, the moving trajectory of the pointing device is outputted to the display device (Step S616). Whereas, if the compensated moving trajectory does not need to be shown on the display device, the calculated position-compensating data is stored and the recorded position of the position is updated (Step S617).

For further understanding the method of performing a shift estimation operation, the steps S611, S612 and S613 will be illustrated in more details as follows.

In the step S611, a tilt angle of the optical pen mouse is calculated according to the acceleration outputted from the G sensor. Then, the title angle range of holding the optical pen mouse is set to be ±45°. The body coordinate value [x_{b}, y_{b}, z_{b}]^{T} of the pointing device indicates the coordinate value of the pen-shaped body of the pointing device. The supporting plane has a coordinate value [x_{b}, yₙ, zₙ]^{T}. After the tilt angle information is sensed by the G sensor, the coordinate of the pen-shaped body of the pointing device relative to the supporting plane will be acquired. That is, through a transformation matrix, the dynamic operating basis (body coordinate) of the pointing device is transformed to the reference basis (navigation coordinate) according to the following formula:

$$[ \begin{matrix}{x}_{n} \\ {y}_{n} \\ {z}_{n}\end{matrix} ] = [ \begin{matrix}cos θ & sin θ sin φ & sin θ cos φ \\ 0 & cos φ & - sin φ \\ - sin θ & cos θ sin φ & cos θ cos φ\end{matrix} ] [ \begin{matrix}{x}_{b} \\ {y}_{b} \\ {z}_{b}\end{matrix} ] .$$

For estimating the shift in the step S612, the acceleration ^{\vec{α}} outputted from the G sensor is integrated twice to acquire a first set of observed shift data Δ_{\vec{p}}, and a second set of observed shift data ΔPₓ, ΔP_{y} are sensed by the mouse sensor. The first set of observed shift data and the second set of observed shift data are processed by the fuzzy theory and the Kalman filter algorithm, thereby acquiring optimal shift data ΔP′ₓ, ΔP′_{y}.

In the step S613, the attitude angle of the pointing device is estimated by the fuzzy theory and the Kalman filter algorithm. That is, the attitude angle change ^{\vec{ω}} is respectively measured by the gyroscope and the e-compass and then processed by the fuzzy theory and the Kalman filter algorithm, thereby acquiring an optimal attitude angle Θ.

After the estimated shift data ΔP′ₓ, ΔP′_{y} and the estimated attitude angle Θ are obtained in the steps S612 and S613, the moving trajectory change ΔPₓ, ΔP_{y} of the optical mouse pen may be calculated according to the following formula:

$$[ \begin{matrix}Δ {P}_{x} \\ Δ {P}_{y}\end{matrix} ] = [ \begin{matrix}cos Θ & - sin Θ \\ sin Θ & cos Θ\end{matrix} ] [ \begin{matrix}Δ {P}_{x}^{′} \\ Δ {P}_{y}^{′}\end{matrix} ] .$$

After the moving trajectory change of the pointing device is acquired, the touch sensor is used to judge whether the pointing device is contacted with the supporting plane in order to further determine whether the compensated moving trajectory is shown on the display device. If the touch sensor judges that the pointing device is contacted with the supporting plane, it means that the pointing device is used to write. Meanwhile, the moving trajectory of the pointing device shown on the display device according to position-compensating data. On the other hand, if the pointing device is not contacted with the supporting plane, it is not necessary to change the moving trajectory but the position-compensating data is stored to be used in the next position-compensation.

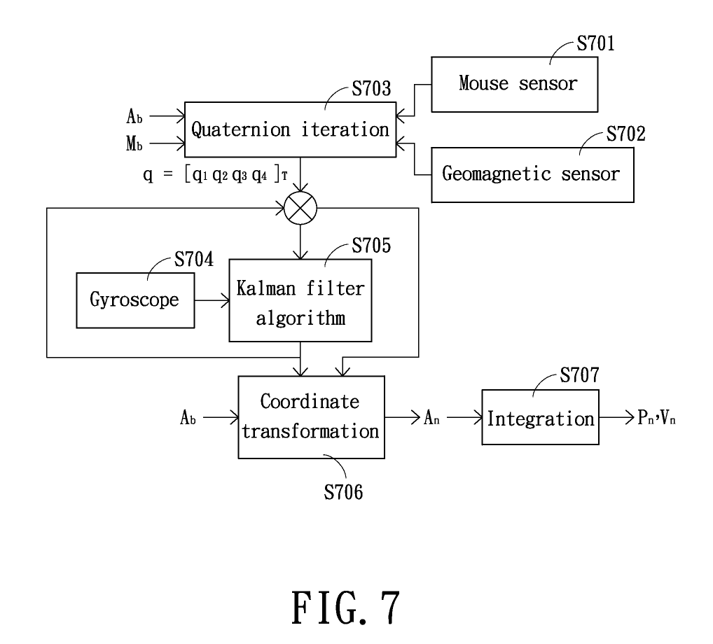

FIG. 7 is a flowchart illustrating a shift estimation operation performed by an optical pen mouse according to a second embodiment of the present invention. Firstly, the acceleration sensed by the mouse sensor (Step S701) and the geomagnetic parameters sensed by the geomagnetic sensor (Step S702) are used as input parameters. Then, quaternion iteration and the recursive data processing algorithm are performed to acquire optimal quaternion (Step S703). Then, the sensing amount acquired by a gyroscope (Step S704) and the optimal quaternion are processed by the Kalman filter algorithm (Step S705). In addition, by a direction cosine matrix (DCM) of the quaternion, the body coordinate value of the dynamic operating basis is transformed into the acceleration data relative to the reference basis (Step S706). After the influence of the gravitational field is eliminated, the acceleration values relative to the reference basis of the supporting plane are acquired. These acceleration values are then integrated to acquire the moving speed and the moving trajectory of the pointing device relative to the supporting plane (Step S707).

Like the first embodiment, the second embodiment also uses sensors to acquire the detected data and the Kalman filter algorithm to perform the shift estimation operation. In comparison with the first embodiment, the second embodiment uses the quaternion to describe the three-dimensional rotation. When compared with the Euler rotation, the use of the quaternion may avoid the singularity of the attitude angle caused by the Euler angle.

From a Wahba's problem, it is found that the attitude angle in the three-dimensional space may be acquired according to at least two sets of known vectors or calculated according to the detected data of respective coordinate systems. The vectors should have a non-zero length and colinearity. In the second embodiment, all space vectors are combined in the algorithm of calculating the attitude angle. In addition, the coordinate system constituted by two vectors (acceleration vector A and magnetic field vector M) is used to express the attitude angle change of the pointing device.

For further understanding the method of performing a shift estimation operation, the steps S703, S705 and S706 will be illustrated in more details as follows.

In the step S703, the acceleration vector A and the magnetic field vector M are taken into consideration. The superscript b denotes the body coordinate system (dynamic operating basis), and the suffix n denotes the navigation coordinate system (reference basis). Consequently, through the direction cosine matrix ^{C}^{ₙ}^{b}^{_{(q)}} of the quaternion, the acceleration vector of the body coordinate system may be expressed by the following formula:

α^{b}=Cₙ^{b}(q)αⁿ

The above formula indicates how the direction cosine matrix (DCM) is used to transform the acceleration information of the navigation coordinate system into the acceleration information of the body coordinate system. As a consequence, by reverse computation of the acceleration information of the body coordinate system, the acceleration information of the navigation coordinate system is obtained. In the Step S703, the quaternion iteration is performed to acquire optimal quaternion, which is used as one of the detected data in the Kalman filter algorithm (Step S705).

Since the equation used in the Kalman filter algorithm in the step S705 has a linear relationship and less computing amount is required, the azimuth angle may be estimated in real time.

In addition, by a direction cosine matrix (DCM) of the quaternion, the body coordinate value of the dynamic operating basis is transformed into the acceleration values relative to the reference basis (Step S706). After the influence of the gravitational field is eliminated, the acceleration values relative to the reference basis of the supporting plane are acquired. That is, ^{α}^{ⁿ}_{=C}_{^{b}}ⁿ^{_{(q)α}}^{b}^{_{−G}}, where ^{G=[0, 0, -g]}. These acceleration values are then integrated to acquire the moving speed and the moving trajectory of the pointing device relative to the supporting plane.

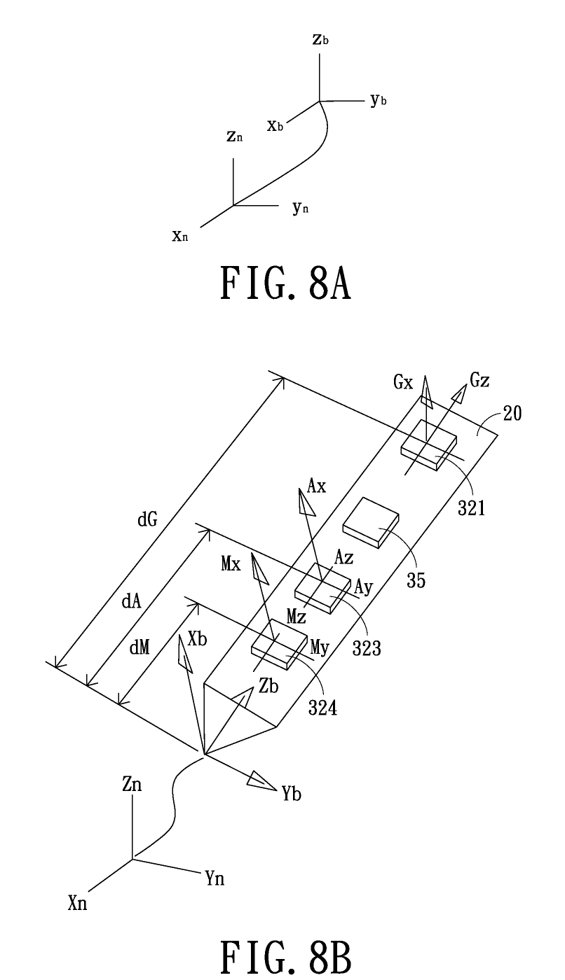

FIG. 8A schematically illustrates the relationship between the body coordinate system (dynamic operating basis) and the navigation coordinate system (reference basis) according to the present invention. The coordinate system xₙ-yₙ-zₙ in the lower-left side denotes the reference basis of the supporting plane, i.e. the navigation coordinate system of the supporting plane where the pointed device is contacted. The coordinate system x_{b}-y_{b}-z_{b} in the upper-right denotes the dynamic operating basis (i.e. a body coordinate system) of the pointing device. In response to a user's operating behavior (e.g. movement, rotation or a rolling action) on the pointing device, the position of the pointing device relative to the supporting plane is changed. Due to the configuration change, the dynamic operating basis of the pointing device is changed. That is, the coordinate system x_{b}-y_{b}-z_{b} (i.e. the body coordinate system) is changed as position of the pointing device relative to the supporting plane is changed.

FIG. 8B schematically illustrates the detected information acquired by a sensing unit of a pen-shaped pointing device relative to the reference basis and the operating basis. Similarly, as shown in FIG. 8A, the coordinate system xₙ-yₙ-zₙ denotes the reference basis of the supporting plane, and the coordinate system x_{b}-y_{b}-z_{b} at the tip of the pointing device 20 denotes the dynamic operating basis.

Since the dynamic operating basis is changed in response to the user's operating behavior on the pointing device, the sensor is used to detect the changes of the position and the rotating angle. As shown in FIG. 8B, the pointing device 20 comprises a microcontroller 35, a gyroscope 321, a G sensor 323 and a geomagnetic sensor 324. The gyroscope 321, the G sensor 323 and the geomagnetic sensor 324 for used to sense corresponding sensing amount, which are then combined to be further computed. It is noted that the sensors used in the pointing device 20 are not restricted to the above-mentioned types of sensors.

Different types of sensing units within the pen-shaped pointing device 20 are used to obtain different types of detected data. For example, the gyroscope 321 is used to acquire the sensing amount relative to the Gₓ-G_{z} coordinate system, the G sensor 323 is used to acquire the sensing amount relative to the Aₓ-A_{y}-A_{z} coordinate system, and the geomagnetic sensor 324 is used to acquire the sensing amount relative to the Mₓ-M_{y}-M_{z} coordinate system. These detected data are collectively transmitted to the microcontroller 35. Depending on the settings of the shift control system, the shift estimation operation is performed by the microcontroller 35 according to these detected data, or these detected data are transmitted to the controlled device 21 (e.g. a computer) and then the shift estimation operation is performed by the controlled device 21 according to these detected data. It is noted that the functions of the sensors and the microprocessor may be implemented by a single physical component. Similarly, this physical component may sense different detected data and perform the shift estimation operation to acquire the position-compensation data according to the detected data.

The method of performing the shift estimation operation by using sensors to acquire the position-compensating data has been described in the above two embodiment. It is found that the present invention may obviate the drawbacks encountered from the prior art. On the other hand, when identification codes are assigned to plural plurality of pointing devices, the shift control method of present invention may be used to detect the dynamic shift information of a plurality of pointing devices and show the moving trajectories of the plurality of pointing devices.

The present invention is illustrated by referring to a pen-shaped pointing device. Nevertheless, the shift control method of present invention may be applied to any shaped pointing device as long as the pointing device has sensing units to sense the detected information and the moving trajectory of the pointing device is estimated according to the detected information.

From the above description, the shift control method of present invention is capable of dynamically estimating the shift of the pointing device by using the sensors and the Kalman filter algorithm to implement the shift estimation operation. After the shift estimation operation is performed, the dynamic position status of the pointing device is updated. As a consequence, the moving trajectory of the pointing device shown on the display device will be dynamically adjusted in real time.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A shift control method for use with a pen-shaped pointing device and a controlled device, the shift control method comprising steps of:
sensing shift information, tilt angle information and rotating angle information in response to a configuration change of the pointing device relative to a supporting plane;
performing a shift estimation operation by the controlled device according to the shift information, the tilt angle information and the rotating angle information, thereby acquiring a position-compensating data; and
adjusting a moving trajectory of the pointing device displayed by the controlled device according to the position-compensating data if the pointing device is in contact with the supporting plane.

2. The shift control method according to claim 1, wherein the configuration change of the pointing device relative to the supporting plane is caused by moving, rotating or rolling the pointing device on the supporting plane.

3. The shift control method according to claim 1 further comprising steps of:
providing a reference basis associated with the controlled device;
providing a dynamic operating basis associated with the pointing device; and
adjusting the moving trajectory of the pointing device relative to the reference basis according to the dynamic operating basis and the position-compensating data.

4. The shift control method according to claim 3 wherein the dynamic operating basis of the pointing device is adjusted according to the configuration change of the pointing device relative to the supporting plane.

5. The shift control method according to claim 1 further comprising steps of:
assigning an identification code to the pointing device;
acquiring the identification code by the controlled device when the controlled device is in communication with the pointing device; and
adjusting the moving trajectory of the pointing device displayed by the controlled device according to the identification code and the position-compensating data.

6. The shift control method according to claim 1, wherein the shift information, the tilt angle information and the rotating angle information are provided by an optical shift sensor, a track ball shift sensor, an acceleration sensor, a gyroscope, an e-compass or a geomagnetic sensor.

7. A pen-shaped pointing device in communication with a controlled device, comprising:
a pen-shaped body; and
a sensing unit disposed in the pen-shaped body for detecting shift information, tilt angle information and rotating angle information in response to a configuration change of the pointing device relative to a supporting plane, wherein the controlled device performs a shift estimation operation according to the shift information, the tilt angle information and the rotating angle information to acquire a position-compensating data, wherein if the pointing device is in contact with the supporting plane, the controlled device adjusts a moving trajectory of the pointing device displayed by a controlled device according to the position-compensating data.

8. The pen-shaped pointing device according to claim 7, wherein the configuration change of the pointing device relative to the supporting plane is caused by moving, rotating or rolling the pointing device on the supporting plane.

9. The pen-shaped pointing device according to claim 8, wherein the controlled device is associated with a reference basis, and the pointing device is associated with a dynamic operating basis, wherein in response to the configuration change of the pointing device relative to the supporting plane, the moving trajectory of the pointing device relative to the reference basis is adjusted according to the dynamic operating basis and the position-compensating data.

10. The pen-shaped pointing device according to claim 7, wherein the pen-shaped pointing device further comprises a transmitting unit in communication with the controlled device for transmitting the shift information, the tilt angle information and the rotating angle information to the controlled device.

11. The pen-shaped pointing device according to claim 10, wherein an identification code is assigned to the pointing device and transmitted to the controlled device through the transmitting unit, wherein the moving trajectory of the pointing device displayed by the controlled device is adjusted according to the identification code and the position-compensating data.

12. The pen-shaped pointing device according to claim 7 wherein the sensing unit is an optical shift sensor, a track ball shift sensor, an acceleration sensor, a gyroscope, an e-compass or a geomagnetic sensor.

13. A shift control system, comprising:
at least one pointing device comprising a casing and a sensing unit, wherein the sensing unit is disposed inside the casing for detecting shift information, tilt angle information and rotating angle information in response to a configuration change of the pointing device relative to a supporting plane; and
a controlled device in communication with the at least one pointing device for performing a shift estimation operation according to the shift information, the tilt angle information and the rotating angle information to acquire a position-compensating data, wherein if the pointing device is in contact with the supporting plane, the controlled device adjusts a moving trajectory of the pointing device displayed by a controlled device according to the position-compensating data.

14. The shift control system according to claim 13, wherein the sensing unit is an optical shift sensor, a track ball shift sensor, an acceleration sensor, a gyroscope, an e-compass or a geomagnetic sensor.
